(19) United States
(12) Patent Application Publication
(10) Pub. No.: US 2013/0259126 A1
(43) Pub. Date: Oct. 3, 2013

(54) METHOD AND APPARATUS FOR VIDEO ENCODING/DECODING OF ENCODING/DECODING BLOCK FILTER INFORMATION ON THE BASIS OF A QUADTREE

(71) Applicants: Jinhan Song, Seoul (KR); Jeongyeon Lim, Gyeonggi-do (KR); Tae Young Jung, Seoul (KR); Tae Ho Kim, Seongnam-Si (KR); Jechang Jeong, Seoul (KR)

(72) Inventors: Jinhan Song, Seoul (KR); Jeongyeon Lim, Gyeonggi-do (KR); Tae Young Jung, Seoul (KR); Tae Ho Kim, Seongnam-Si (KR); Jechang Jeong, Seoul (KR)

(73) Assignee: SK TELECOM CO., LTD., Seoul (KR)

(21) Appl. No.: 13/882,495

(22) PCT Filed: Oct. 26, 2011
(86) PCT No.: PCT/KR2011/008024

§ 371 Date: Jun. 13, 2013

(30) Foreign Application Priority Data
Oct. 29, 2010 (KR) 10-2010-0106869

(51) Int. Cl. H04N 7/46

(52) U.S. Cl. CPC H04N 19/00751
USPC 375/240.12

(57) ABSTRACT

In a video encoding and/or decoding apparatus and/or method, a video encoder partitions a reference image predicted block-wise with at least a filter into blocks in at least one layer, sets a partitioning flag to indicate whether each of the partitioned blocks is subdividable into sub-blocks, sets a filter type to indicate which filter was used for interpolating each of the blocks or sub-blocks, and quadtree-encodes the partitioning flag and the filter type together with the corresponding block or sub-block to generate a quadtree-encoded bitstream. A video decoder reads the partitioning flags and the filter types from the quadtree-encoded bitstream to reconstruct the partitioning flags and the filter types for the corresponding blocks or sub-blocks, generates the blocks or sub-blocks based on the corresponding partitioning flags, and interpolates the generated blocks or sub-blocks on the basis of the corresponding filter types to reconstruct the reference image.

### CROSS-REFERENCE TO RELATED APPLICATION

The instant application is the US national phase of PCT/KR2011/008024, filed Oct. 26, 2011, which claims priority to Korean Patent Application No. 10-2010-0106869, filed on Oct. 29, 2010. The above-listed applications are hereby incorporated by reference in their entirety.

### TECHNICAL FIELD

The present disclosure relates to an apparatus and a method for encoding/decoding images and/or video.

### BACKGROUND

The statements in this section merely provide background information related to the present disclosure and may not necessarily constitute prior art.

For video compression, inter prediction is a common technique in video compression. A recent inter prediction technique utilizes a reference image which is interpolated by non-integer pixel unit. As a result, performance has been significantly improved over video compression techniques performed by integer pixel unit. In addition, the latest H.264/AVC video coding/decoding for video compression employs a reference image which is interpolated by non-integer pixel unit of up to quarter pixel unit.

For a reference image, H.264/AVC uses the following interpolation method. In a first step, to generate pixels at locations aa, bb, b, hh, ii, jj, cc, dd, h, ee, ff and gg in FIG. 1, respective pixels are interpolated by applying a 6-tap filter (1, −5, 20, 20, −5, 1) in vertical and horizontal directions. For interpolation at a location j, the 6-tap filter is equally applied to locations aa, bb, b, hh, ii and jj. In a second step, the pixels at locations a, c, i and k are interpolated by applying a linear interpolation method in a horizontal direction and the pixels at locations d, f, l and n are interpolated by applying the linear interpolation method in a vertical direction. The pixels at locations e, g, m and o are interpolated through linear interpolation based on pixels at the middle locations in a diagonal direction by using the method of e=(b+h+1)>>1, g=(b+ee+1)>>1, m=(h+hh+1)−1, o=(ee+hh+1)−1.

The above-described interpolation method uses the 6-tap filter having fixed values (1, −5, 20, 20, −5, 1) in order to interpolate pixel values at non-integer locations. However, a filter having fixed coefficients hardly reflects characteristics of individual images. Accordingly, an Adaptive Interpolation Filter (AIF) has been developed to calculate optimal filter coefficients for each image (or video frame) in consideration of the characteristics of each image for use in an interpolation filter for that image. FIG. 1 is an exemplary diagram schematically showing an image interpolated to the level of quarter pixel unit. In the AIF, a one-dimensional filter is defined in order to generate pixels at locations a, b, c, d, h and I in FIG. 1. To calculate pixels at the remaining locations e, f, g, i, j, k, m, n and o, respective two-dimensional filters are defined for the pixels at the respective locations. Non-integer pixels with two-dimensional filters defined can be predicted by performing 2D-convolution of the pixel values and the defined two-dimensional filters with a reference image of integer unit as in Equation 1. The pixels with one-dimensional filters defined are predicted by performing 1D-convolution of the pixel values and the defined one-dimensional filters with the reference image of integer unit.

$${p}^{FP} = {\sum }_{i = 1}^{N} {\sum }_{j = 1}^{N} {P}_{i , j} {h}_{i - 1 , j - 1}^{FP} \qquad Equation 1$$

In Equation 1, p^{FP} represents interpolated non-integer pixel values at locations e, f, g, i, j, k, m, n and o, at which two-dimensional filters are defined, and P_{i, j} represents pixel values at integer locations included in a reference image. h^{FP}_{i-1,j-1} is a filter coefficient. Prediction error can be defined as a difference between a pixel S_{X,Y} in a current original image and a pixel P_{\tilde{x},\tilde{y}}^{FP} predicted from the reference image. As a result, the filter coefficient can be calculated to minimize prediction error energy as in Equation 2:

$${( {e}^{FP} )}^{2} = {\sum }_{x} {\sum }_{y} ( {S}_{x , y} - {\sum }_{i = 1}^{N} {\sum }_{j = 1}^{N} {P}_{\tilde{x} + i , \tilde{y} + j} {h}_{i , j}^{FP} ) \qquad Equation 2$$

In Equation 2, \tilde{x}=x+mvₓ−FO, \tilde{y}=y+mv_{y}−FO. (mv_{X},mv_{y}) is motion information, and FO is a filter offset FO=filter_size/2−1. As described above, a method for acquiring a filter coefficient for minimization of prediction error is commonly applied to AIF-based filters.

The number of filter coefficients in AIF is N at the location of each non-integer pixel with a one-dimensional filter defined, and is N×N in each non-integer pixel with a two-dimensional filter defined. As a result, the number of respective reference filter coefficients is N×N×9+N×6 for each image (or video frame). Generally, since 6-tap filters (i.e., N=6) are used in H.264/AVC, the number of filter coefficients is 360.

The AIF predicts a reference image more precisely than the interpolation method of H.264/AVC. In addition, in order to improve prediction of a reference image, various interpolation filters, such as a non-separable AIF, directional AIF, enhanced DAIF, enhanced AIF, high precision filter, or switch Interpolation filter with offset, have been developed which further increases the amount of information to be considered for encoding/decoding.

### SUMMARY

In accordance with some embodiments, in a video encoding/decoding apparatus and/or method, a video encoder partitions a reference image predicted block-wise with at least a filter into blocks in at least one layer, sets a partitioning flag to indicate whether each of the partitioned blocks is subdividable into sub-blocks, sets a filter type to indicate which filter was used for interpolating each of the blocks or sub-blocks, and quadtree-encodes the partitioning flag and the filter type together with the corresponding block or sub-block to generate a quadtree-encoded bitstream. A video decoder reads the partitioning flags and the filter types from the quadtree-encoded bitstream to reconstruct the partitioning flags and the filter types for the corresponding blocks or sub-blocks, generates the blocks or sub-blocks based on the corresponding partitioning flags, and interpolates the generated blocks or sub-blocks on the basis of the corresponding filter types to reconstruct the reference image.

In accordance with some embodiments, in a video encoding apparatus and/or method, a reference image predicted block-wise with at least a filter is partitioned into blocks in at least one layer. A partitioning flag is set to indicate whether each of the partitioned blocks is subdividable into sub-blocks. A filter type is set to indicate which filter was used for interpolating each block or sub-block. The partitioning flag and the filter type are encoded together with the corresponding block or sub-block.

In accordance with some embodiments, in a video decoding apparatus and/or method, partitioning flags and filter types corresponding blocks or sub-blocks are read from a quadtree-encoded bitstream to reconstruct the partitioning flags and the filter types. The blocks or sub-blocks are generated based on the partitioning flags. A reference image is reconstructed for use in a motion compensation by interpolating the generated blocks or sub-blocks based on the corresponding filter types.

### DESCRIPTION OF DRAWINGS

FIG. 1 is an exemplary diagram schematically showing an image interpolated to the level of quarter pixel unit;

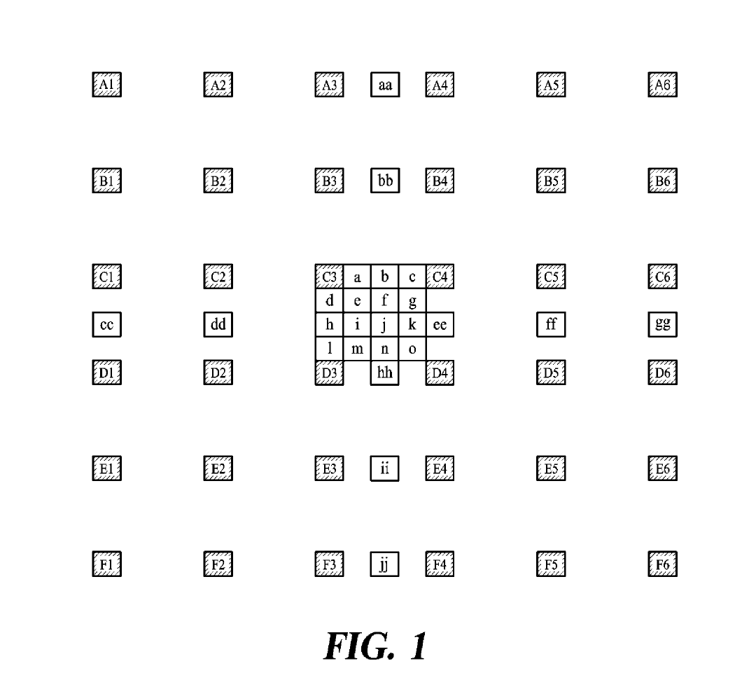

FIG. 2 is a diagram schematically showing an apparatus for video encoding/decoding according to one or more embodiments of the present disclosure;

FIG. 3 is a diagram schematically showing block filter information and an exemplary quadtree partitioning structure according to one or more embodiments of the present disclosure;

FIG. 4 is a diagram schematically showing an example in which the filter information of the blocks of FIG. 3 is quadtree-encoded according to one or more embodiments of the present disclosure;

FIG. 5 is a diagram schematically showing an example where one filter is used for blocks constituting a lower layer according to one or more embodiments of the present disclosure;

FIG. 6 is a flow diagram showing a method for encoding block filter information based on quadtree partitioning according to one or more embodiments of the present disclosure; and

FIG. 7 is a flow diagram showing a method for decoding block filter information based on quadtree partitioning according to one or more embodiments of the present disclosure.

### DETAILED DESCRIPTION

Some embodiments of the present disclosure provide video encoding/decoding method and apparatus for block-wise selecting and expressing of an optimal filter for interpolation of a reference image in non-integer pixel-level prediction, for quadtree-encoding information of the filter expressed block-wise, for decoding an encoded bitstream before identifying the block filter information to generate an optimal reference image in non-integer unit, and for encoding/decoding block filter information using quadtree partitioning, in order to minimize a difference between an original image and a predictive image when motion compensated prediction is performed.

Hereinafter, at least one embodiment of the present disclosure will be described in detail with reference to the accompanying drawings. In the following description, like reference numerals designate like elements although the reference numbers are shown in different drawings. Further, in the following description of the at least one embodiment, a detailed description of known functions and/or configurations will be omitted for the purpose of clarity and for brevity.

Additionally, in describing various components of the present disclosure, terms like first, second, A, B, (a) and (b), etc., are used solely for the purpose of differentiating one component from another, and one of ordinary skill in the art would understand the terms do not imply or suggest the substances, order or sequence of the components. If a component is described as ‘connected’, ‘coupled’, or ‘linked’ to another component, one of ordinary skill in the art would understand the components are not necessarily directly ‘connected’, ‘coupled’, or ‘linked’ but also are indirectly ‘connected’, ‘coupled’, or ‘linked’ via at least one additional third component.

A video encoding apparatus and/or a video decoding apparatus according to one or more embodiments may correspond to a user terminal such as a PC (personal computer), a notebook computer, a tablet, a PDA (Personal Digital Assistant), a game console, a PMP (portable multimedia player), a PSP (PlayStation Portable), a wireless communication terminal, a smart phone, a TV, a media player, and the like. A video encoding apparatus and/or a video decoding apparatus according to one or more embodiments may correspond to a server terminal such as an application server, a service server, and the like. A video encoding apparatus and/or a video decoding apparatus according to one or more embodiments may correspond to various devices each including (a) a communication device such as a communication modem that performs communication with various devices or wired/wireless communication networks, (b) a memory that stores various programs and data that encode or decode an image or perform inter/intra-prediction for encoding or decoding, and (c) a microprocessor to execute a program so as to perform calculation and controlling, and the like. According to one or more embodiments, the memory comprises a computer-readable recording/storage medium such as a random access memory (RAM), a read only memory (ROM), a flash memory, an optical disk, a magnetic disk, a solid-state disk, and the like. According to one or more embodiments, the microprocessor is programmed for performing one or more of operations and/or functionality described herein. According to one or more embodiments, the microprocessor is implemented, in whole or in part, by specifically configured hardware (e.g., by one or more application specific integrated circuits or ASIC(s)).

According to one or more embodiments, an image (or video frame) that is encoded by the video encoding apparatus into a bit stream may be transmitted, to the video decoding apparatus in real time or non-real time, through a wired/wireless communication network such as the Internet, a wireless personal area network (WPAN), a wireless local area network (WLAN), a WiBro (wireless broadband, aka WiMax) network, a mobile communication network, and the like or through various communication interfaces such as a cable, a USB (Universal Serial Bus), and the like. According to one or more embodiments, the bit stream may be decoded in the video decoding apparatus and may be reconstructed to a video, and the video may be played back. According to one or more embodiments, the bit stream is stored in a computer-readable recording/storage medium.

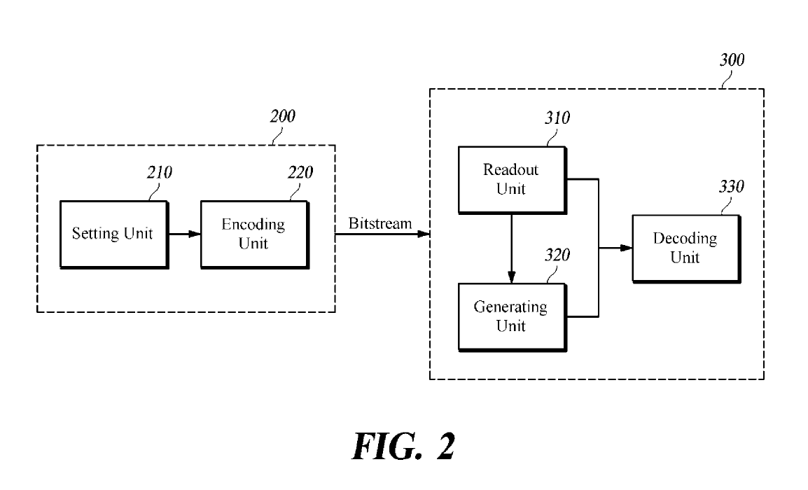

FIG. 2 is a diagram schematically showing an apparatus for video encoding/decoding according to one or more embodiments of the present disclosure.

Referring to FIG. 2, the apparatus for video encoding/decoding includes a video encoder 200 for partitioning a reference image predicted block-wise with at least an optimal filter into blocks in at least one layer, for setting a partitioning flag to indicate whether each of the partitioned blocks is subdividable into sub-blocks, for setting and a filter type of the filter used for predicting each block or sub-block, and for quadtree-encoding the partitioning flag and the filter type. The apparatus for video encoding/decoding further includes a video decoder 300 for reading a partitioning flag and a filter type from a quadtree-encoded bitstream to reconstruct the partitioning flag and the filter type, for generating partitioned blocks on the basis of the partitioning flag, and for interpolating the generated blocks on the basis of filter types corresponding to the generated blocks to reconstruct a reference image for an optimal motion compensation. In this case, although FIG. 2 illustrates that the video decoder 300 receives a bitstream from the video encoder 200 and reconstructs the blocks, the video encoder 200 may transmit the bitstream to another video encoding/decoding apparatus, and the video decoder 300 also may receive a bitstream transmitted from another video encoding/decoding apparatus.

In addition, the video encoder 200 may include a setting unit 210 and an encoding unit 220.

The setting unit 210 partitions a reference image predicted block-wise with at least an optimal filter into blocks in at least one layer, and sets a partitioning flag to indicate whether each of the partitioned blocks is subdividable into sub-blocks, and sets a filter type of the filter used for predicting each block or sub-block. That is, the setting unit 210 sets the partitioning flag to 1 when the current layer of the partitioned block has a lower layer, and sets the partitioning flag to 0 when the current layer of the partitioned block has no lower layer. In addition, the filter types may be determined by using respective interpolation filters, such as a non-separable AIF, directional AIF, enhanced DAIF, enhanced AIF, high precision filter, or switch interpolation filter with offset. In this case, the filters may be not used in an area where motion information is provided by integer unit, thereby setting and encoding of the filter types are omitted.

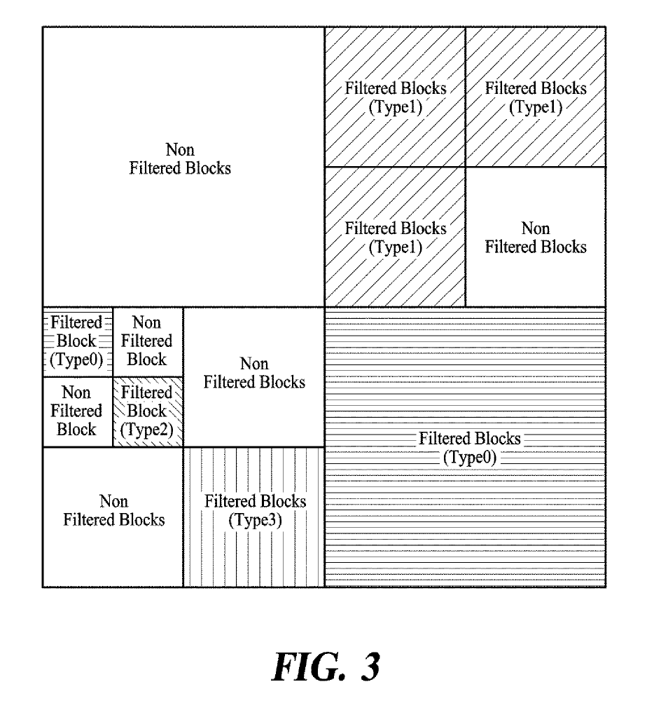

The encoding unit 220 encodes (a) the blocks after the partitioning by the setting unit 210, (b) the partitioning flags corresponding to the respective blocks, and (c) the filter types corresponding to the respective blocks. That is, the encoding unit 220 can quadtree-encode the filter types used for the respective partitioned blocks as illustrated in FIG. 3. In this case, transformation and quantization processes and, de-quantization and inverse-transformation processes may be further performed. These processes are not salient to the point of the embodiments of the present disclosure and the detailed description thereof will be omitted.

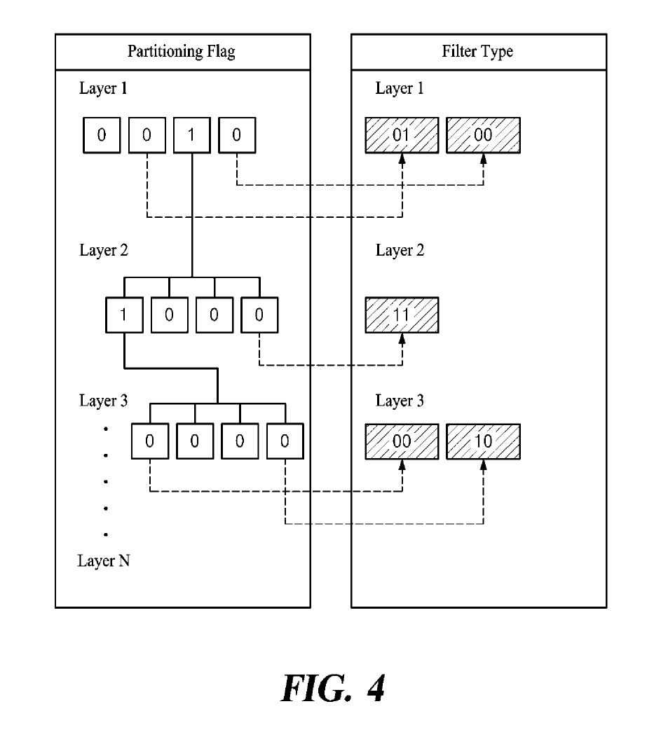

FIG. 4 is a diagram schematically showing an example in which the filter information of the blocks of FIG. 3 is quadtree-encoded according to one or more embodiments of the present disclosure. Referring to FIGS. 3 and 4, a method for quadtree-encoding filter information will be described below in detail.

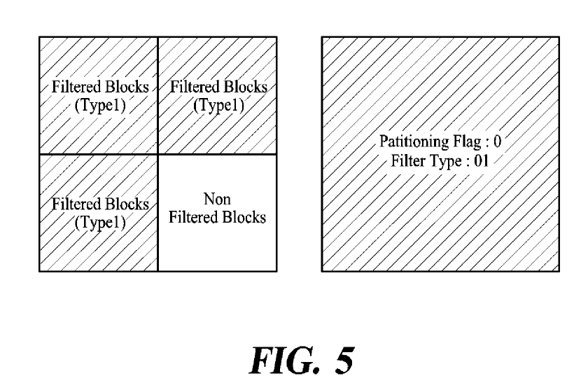

Partitioning a reference image predicted block-wise with at least an optimal filter by layer 1 generates left upper blocks defined as first blocks, right upper blocks as second blocks, left lower block as third blocks, and right lower blocks as fourth blocks. In the case of FIG. 3, since the first blocks in layer 1 have no lower layer, partitioning flags thereof can be set to 0. In addition, since the second blocks have a lower layer with four sub-blocks, the partitioning flags of the second blocks can be set to 1 in some embodiments. However, in at least one embodiment, the partitioning flags of the second blocks can be set to 0 (i.e., the second blocks are considered as having no lower layers) as discussed in detail below with respect to FIG. 5. In addition, since the third blocks have at least one lower layer, the partitioning flags of the third blocks can be set to 1. Since the fourth blocks do not have lower layers, the partitioning flags of the fourth blocks can be set to 0. Therefore, the partitioning flag for layer 1 of the blocks to be encoded can be expressed as 0010 when the second blocks are considered as having no lower layers. When the second blocks are considered as having a lower layer (e.g., layer 2), the partitioning flag for layer 1 of the blocks to be encoded can be expressed as 0110.

In this case, the filter types of the first blocks are not set, because the first blocks use no filters. The filter types of the lower partitioned blocks (i.e., the sub-blocks on layer 2) of the second blocks are all same as type 1 (as discussed in detail with respect to FIG. 5 below), and therefore, can be set to 01 (i.e., “01” is the binary code of type “1”). In addition, the fourth blocks have filter type 0, and therefore, can be set to 00 (i.e., “00” is the binary code of type “0”).

In addition, the third blocks may be partitioned into sub-blocks or lower blocks of a lower layer, and may be represented by a partitioning flag of 1000 in layer 2 in the same manner as described above. Specifically, the third blocks have sub-blocks including first sub-blocks (on layer 2) which have a lower layer (i.e., layer 3), and the partitioning flags of the first sub-blocks (on layer 2) of the third blocks are set to 1. The second, third and fourth sub-blocks (on layer 2) of the third blocks have no lower layers, and are set with the partitioning flags of 0. Thus, the partitioning flag of 1000 in layer 2 of the third blocks is obtained. The fourth sub-blocks (on layer 2) of the third blocks have filter type 3 and can be set to have filter types of 11 (i.e., “11” is the binary code of type “3”).

Similarly, the partitioning flags of the first lower blocks or sub-blocks (on layer 2) of the third blocks can be set to 0000 in layer 3. Filter types of 0 and 2 are used for the first and fourth sub-blocks (on layer 3) of the first lower blocks (on layer 2) of the third blocks of FIG. 3, and therefore, the corresponding filter types can be set to 00 and 10 (i.e., “10” is the binary code of type “2”), respectively.

FIG. 5 is a diagram schematically showing an example where one filter is used for blocks constituting a lower layer according to one or more embodiments of the present disclosure. Specifically, the left part of FIG. 5 shows the second blocks of FIG. 3 as having a lower layer (layer 2) with sub-blocks and one type of filter, i.e., filter type 1. Although the fourth sub-blocks of on layer 2 do not use a filter, as illustrated in the right part of FIG. 5, it should be noted that, in some embodiments, using a single filter for blocks constituting a lower layer allows a single filter type to be set as. As a result, the second blocks of FIG. 3 can be considered as having no lower layers (partitioning flag of 0) and with a single filter type 01 as illustrated in the right part of FIG. 5. Since the fact that a filter is not used for a block (i.e., the fourth sub-blocks of on layer 2) can be known through motion information in that block, encoding of a filter type for the block that uses no filter can be omitted, thereby reducing the amount of information to be encoded and/or transmitted and/or decoded. In some embodiments, when, in addition to the fourth sub-blocks, one or two other sub-blocks (e.g., second and third sub-blocks on layer 2) of the second blocks of FIG. 3 also use no filter, the second blocks of FIG. 3 can still be encoded as illustrated in the right part of FIG. 5.

On the other hand, the video decoding apparatus, i.e., decoder 300, according to at least one embodiment of the present disclosure may include a readout unit 310, a generating unit 320 and a decoding unit 330 as illustrated in FIG. 2.

The readout unit 310 reads a partitioning flag and the filter type corresponding to respective blocks from the quadtree-encoded bitstream to reconstruct the partitioning flag and the filter type. In this case, similar to the video encoder 200, the partitioning flag is identified as 1 for a layer with lower layers, and identified as 0 for a layer without lower layers.

The generating unit 320 generates blocks on the basis of partitioning flag. Since a method for generating blocks is similar to a general block generating method, the detailed description thereof is omitted.

The decoding unit 330 identifies information of filters used for respective blocks on the basis of filter types, and interpolates blocks generated by the generating unit 320 on the basis of the corresponding filter types to reconstruct the blocks. The foregoing process is repeatedly performed with respect to all partitioned blocks, thereby reconstructing a reference image for optimal motion compensation. In this case, the decoding unit 330 may perform typical de-quantization and inverse-transformation processes. These processes are not salient to the point of the embodiments of the present disclosure and the detailed description thereof is omitted.

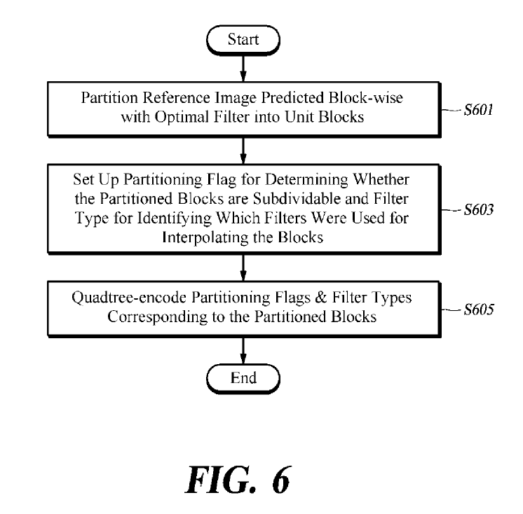

FIG. 6 is a flow diagram showing a method for encoding block filter information based on quadtree partitioning according to one or more embodiments of the present disclosure.

Referring to FIGS. 2 and 6, the setting unit 210 partitions a reference image predicted block-wise with at least an optimal filter into blocks by at least one layer (step S601), and sets a partitioning flag to indicate whether each of the partitioned blocks has lower layers or sub-blocks, and setting a filter type corresponding to the kind of the filter used (step S603). That is, the setting unit 210 sets a partitioning flag to 1 when there is a lower layer in a block or a partitioned sub-block to be encoded, and sets the partitioning flag to 0 when there are no lower layers. In addition, the filter types may be determined by using respective interpolation filters, such as non-separable AIF, directional AIF, enhanced DAIF, enhanced AIF, high precision filter, or switch interpolation filter with offset. In this case, the filters may be not used in an area where motion information is provided by integer unit, thereby setting and encoding of filter types are omitted.

The encoding unit 220 quadtree-encodes the blocks generated by the setting unit 210, the partitioning flags corresponding to the respective blocks, and the filter types corresponding to the respective blocks (step S605).

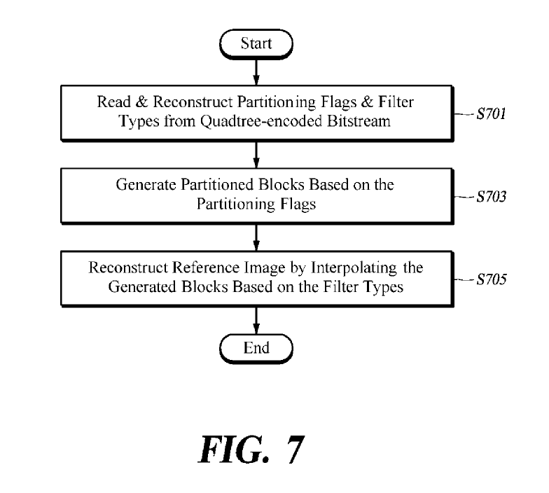

FIG. 7 is a flow diagram showing a method for decoding block filter information based on quadtree partitioning according to one or more embodiments of the present disclosure.

Referring to FIGS. 2 and 7, the readout unit 310 reads partitioning flags and filter types corresponding to respective blocks from a quadtree-encoded bitstream to reconstruct the partitioning flags and the filter types (step S701). In this case, similar to the video encoder 200, the partitioning flag is identified as 1 for a layer with lower layers, and identified as 0 for a layer without lower layers.

The generating unit 320 generates blocks on the basis of partitioning flags (S703). Since a method for generating blocks is similar to a general block generating method, the detailed description thereof is omitted.

The decoding unit 330 identifies filter information used for respective blocks on the basis of filter types, and interpolates blocks generated by the generating unit 320 on the basis of the corresponding filter types to reconstruct the blocks (step S705). In this case, the decoding unit 330 may perform typical de-quantization and inverse-transformation processes. These processes are not salient to the point of the embodiments of the present disclosure and the detailed description thereof is omitted.

According to the present disclosure as described above, optimal reference images of non-integer unit can be reconstructed by selecting and expressing an optimal filter by block unit, quadtree-encoding filter information expressed by block unit, decoding an encoded bitstream, and identifying the filter information expressed for each block, in order to minimize error upon prediction of a reference image.

In the description above, although all of the components of the embodiments of the present disclosure may have been explained as assembled or operatively connected as a unit, one of ordinary skill would understand the present disclosure is not limited to such embodiments. Rather, within some embodiments of the present disclosure, the respective components are selectively and operatively combined in any number of ways. Every one of the components are capable of being implemented alone in hardware or combined in part or as a whole and implemented in a computer program having program modules residing in computer readable media and causing a processor or microprocessor to execute functions of the hardware equivalents. Codes or code segments to constitute such a program are understood by a person skilled in the art. The computer program is stored in a non-transitory computer readable media, which in operation realizes the embodiments of the present disclosure. The computer readable media includes magnetic recording media, optical recording media, in some embodiments.

In addition, one of ordinary skill would understand terms like ‘include’, ‘comprise’, and ‘have’ to be interpreted in default as inclusive or open-ended rather than exclusive or close-ended unless expressly defined to the contrary. All the terms that are technical, scientific or otherwise agree with the meanings as understood by a person skilled in the art unless defined to the contrary.

Although exemplary embodiments of the present disclosure have been described for illustrative purposes, those skilled in the art will appreciate that various modifications, additions and substitutions are possible, without departing from various characteristics of the disclosure. Therefore, exemplary embodiments of the present disclosure have been described for the sake of brevity and clarity. Accordingly, one of ordinary skill would understand the scope of the disclosure is not limited by the explicitly described above embodiments.

1-16. (canceled)

17. A video encoding and decoding apparatus, comprising:
a video encoder configured to
partition a reference image predicted block-wise with at least a filter into blocks in at least one layer,
set a partitioning flag to indicate whether each of the partitioned blocks is subdividable into sub-blocks,
set a filter type to indicate which filter was used for interpolating each of the blocks or sub-blocks, and
quadtree-encode the partitioning flag and the filter type together with the corresponding block or sub-block to generate a quadtree-encoded bitstream; and
a video decoder configured to
read the partitioning flags and the filter types from the quadtree-encoded bitstream to reconstruct the partitioning flags and the filter types for the corresponding blocks or sub-blocks,
generate the blocks or sub-blocks based on the corresponding partitioning flags, and
interpolate the generated blocks or sub-blocks on the basis of the corresponding filter types to reconstruct the reference image.

18. The video encoding and decoding apparatus of claim 17, wherein the at least one filter is an optimal filter for predicting the reference image in non-integer pixel-level prediction.

19. A video encoding apparatus, comprising:
a setting unit configured to
partition a reference image predicted block-wise with at least one filter into blocks in at least one layer,
set a partitioning flag to indicate whether each of the partitioned blocks is subdividable into sub-blocks, and
set a filter type corresponding to each block or sub-block; and
an encoding unit configured to encode the blocks generated by the setting unit, the partitioning flag corresponding to each of the blocks or sub-block, and the filter type corresponding to said each block or sub-block.

20. The video encoding apparatus of claim 19, wherein the setting unit is configured to set the partitioning flag to 1 for each block or sub-block with a lower layer.

21. The video encoding apparatus of claim 19, wherein the setting unit is configured to set the partitioning flag to 0 for each block or sub-block with no lower layers.

22. The video encoding apparatus of claim 19, wherein the setting unit is configured to set no filter type for a block or sub-block having motion information in integer unit.

23. The video encoding apparatus of claim 19, wherein the encoding unit is configured to quadtree-encode filter information expressed for said each block.

24. The video encoding apparatus of claim 19, wherein, for each block having a lower layer with sub-blocks among which at least one of the sub-blocks does not use a filter whereas the remaining sub-blocks use a same filter, the setting unit is configured to set for said block
the partitioning flag indicating that said block has no lower layers, and
the filter type indicating the filter used for the remaining sub-blocks.

25. A video decoding apparatus, comprising:
a readout unit configured to read partitioning flags and filter types corresponding to blocks or sub-blocks from a quadtree-encoded bitstream to reconstruct the partitioning flags and the filter types;
a generating unit configured to generate the blocks or sub-blocks based on the corresponding partitioning flags; and
a decoding unit configured to reconstruct a reference image for use in a motion compensation by interpolating the generated blocks based on the corresponding filter types.

26. The video decoding apparatus of claim 25, wherein the readout unit is configured to identify the corresponding partitioning flag as 1 for each block or sub-block with a lower layer.

27. The video decoding apparatus of claim 25, wherein the readout unit is configured to identify the corresponding partitioning flag as 0 for each block or sub-block without a lower layer.

28. The video decoding apparatus of claim 25, wherein, for each block having a lower layer with sub-blocks among which at least one of the sub-blocks does not use a filter whereas the remaining sub-blocks use a same filter,
the readout unit is configured to indicate for said block
the partitioning flag indicating that said block has no lower layers, and
the filter type indicating the filter used for the remaining sub-blocks.

29. A video encoding method, comprising:
partitioning a reference image predicted block-wise with at least a filter into blocks in at least one layer,
setting a partitioning flag to indicate whether each of the partitioned blocks is subdividable into sub-blocks,
setting a filter type to indicate which filter was used for interpolating each block or sub-block; and
encoding the partitioning flag and the filter type together with the corresponding block or sub-block.

30. The video encoding method of claim 29, wherein setting the partitioning flag includes setting the partitioning flag to 1 for each block or sub-block with a lower layer.

31. The video encoding method of claim 29, wherein setting the partitioning flag includes setting the partitioning flag to 0 for each block or sub-block without a lower layer.

32. The video encoding method of claim 29, wherein a block or sub-block having motion information in integer unit neither uses a filter nor set with a filter type.

33. The video encoding method of claim 29, wherein, for each block having a lower layer with sub-blocks among which at least one of the sub-blocks does not use a filter whereas the remaining sub-blocks use a same filter,
the partitioning flag is set for said block to indicate that said block has no lower layers, and
the filter type is set for said block to indicate the filter used for the remaining sub-blocks.

34. A video decoding method, comprising:
reading partitioning flags and filter types corresponding blocks or sub-blocks from a quadtree-encoded bitstream to reconstruct the partitioning flags and the filter types;
generating the blocks or sub-blocks based on the partitioning flags; and
reconstructing a reference image for use in a motion compensation by interpolating the generated blocks or sub-blocks based on the corresponding filter types.

35. The video decoding method of claim 34, wherein the partitioning flags are identified as 1 for blocks or sub-blocks with a lower layer, and as 0 for blocks or sub-blocks without a lower layer.

36. A video encoding and decoding method, comprising:
partitioning a reference image predicted block-wise with at least a filter into blocks in at least one layer;
setting a partitioning flag to indicate whether each of the partitioned blocks is subdividable into sub-blocks;
setting a filter type to indicate which filter was used for interpolating each of the blocks or sub-blocks;
quadtree-encoding the partitioning flag and the filter type together with the corresponding block or sub-block to generate a quadtree-encoded bitstream;
reading the partitioning flags and the filter types from the quadtree-encoded bitstream to reconstruct the partitioning flags and the filter types for the corresponding blocks or sub-blocks;
generating the blocks or sub-blocks based on the corresponding partitioning flags; and
interpolating the generated blocks or sub-blocks on the basis of the corresponding filter types to reconstruct the reference image.
